(19) United States
(12) Patent Application Publication
(10) Pub. No.: US 2006/0253433 A1
(43) Pub. Date: Nov. 9, 2006

(54) Method and apparatus for knowledge-based music searching and method and apparatus for managing music file

(75) Inventors: Sangkyun Kim, Yongin-si (KR); Jiyeun Kim, Seoul (KR); Yongman Ro, Daejeon-si (KR); Soungji Yang, Wonju-si (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRONICS CO., LTD., Suwon-si (KR); RESEARCH & INDUSTRIAL COOPERATION GROUP, Daejeon-si (KR)

(21) Appl. No.: 11/418,260

(22) Filed: May 5, 2006

(30) Foreign Application Priority Data
May 9, 2005 (KR) 10-2005-0038490

(51) Int. Cl. G06F 17/30

(52) U.S. Cl. 707/3

(57) ABSTRACT

A method and apparatus for performing a knowledge-based music search for a music file of a music album, and a method and apparatus for managing the music file. The method includes: inputting a knowledge-based query to a knowledge-based search engine; acquiring a knowledge document relating to the music searched for by the query; reading the query for searching for a desired music file from the knowledge document; and performing a knowledge-based music search using the read query. The method of managing a music file list of a knowledge-based search engine includes: managing a web document and checking for changes in the web document; reading header information of a music file from the web document, if there are any changes in the web document; reading knowledge information relating to the read header information from the web document; and generating a list by indexing the read music knowledge information and the header information corresponding to the music knowledge information.

### CROSS-REFERENCE TO RELATED APPLICATION

This application claims the benefit of Korean Patent Application No. 10-2005-0038490, filed on May 9, 2005, in the Korean Intellectual Property Office, the disclosure of which is incorporated herein by reference.

### BACKGROUND OF THE INVENTION

1. Field of the Invention

The present invention relates to a music file search, and more particularly, to a method and apparatus for performing a knowledge-based music search of a music album, and a method and apparatus for managing a music file.

2. Description of Related Art

Music is generally made by professionals rather than amateurs, unlike home photos. These days, portable devices such as home servers and MP3 players are popular for listening to music. Most music files have a header which includes information such as the artist, composer, release date, and even lyrics.

A music album may index music files to categorize the music files based on the header information, and may store the categories in a storage device to search for music based on the categories some time later. Since this method is simpler and more effective than a music content-based search, many music player devices use this method.

For an effective music search, music files may be indexed and searched in a music content-based way, such as a query by humming (QBH) method or a query by sampling (QBS) method. In these methods, a bar of music is input by humming or sampling, the characteristics of the input music are extracted, and similarities to the extracted characteristics are searched for in a music database. However, these methods produce varying search rates based on whether the bar of the music is correctly hummed or sampled. Moreover, the search rates decrease when searching large numbers of music files.

In general, music is a part of culture and is enjoyed and analyzed by many people. A method of appreciating music and a method of analyzing music can be useful knowledge information for understanding the music, and can be a key factor to search for the music and enjoy the music. For example, a search query focusing on the appreciation of “the music of meditation and relaxing” may be useful to a music listener. However, there is a limit in using such a query in a header-based category search or a music content-based search, which leads to a demand for a knowledge-based category search. The knowledge-based music search may be essential for a music player of a home server, such as an MP3 player or a portable music player, rather than a big capacity server.

However, the conventional category-based music search or content-based music search has a problem in that general knowledge on music cannot be searched, since a search operation is limited to within the well-formed category or to one bar of music.

### BRIEF SUMMARY

An aspect of the present invention provides a method and apparatus for performing a knowledge-based music search for a music file of a music album, which carries out a knowledge-based search for a music album of the home server or a music player of a mobile phone.

An aspect of the present invention also provides a method and apparatus for managing a music file list of a knowledge-based search engine providing a music file list corresponding to a music knowledge-based query.

According to an aspect of the present invention, there is provided a method of performing a knowledge-based music search, including: (a) inputting a knowledge-based query to a knowledge-based search engine; (b) acquiring a knowledge document relating to the music searched for by the query; (c) reading a query for searching for a desired music file from the knowledge document; and (d) performing a knowledge-based music search using the read query.

The knowledge-based search engine may be a knowledge-based web search engine operated on the Internet.

The knowledge document may be an HTML or XML type document.

In operation (c), header information of a header-based music album storage device may be read from the knowledge document.

The operation (c) may include: counting the number of matches between the header information stored in the header-based music album storage device and the knowledge document; acquiring header information of which the number of matches between the header information and the knowledge document is greater than a predetermined number; and converting the acquired header information into a search query for the header-based music album storage device, wherein, in operation (d), a knowledge-based music search in the header-based music album storage device may be performed using the converted query.

The header-based music album storage device may be a local header-based music album storage device or a web-based music service storage device.

The operation (d) may include: searching for a music file using the converted search query in the local header-based music album storage device and a music web site; generating a music file list by combining a search result from the local storage device and a search result from the music web site; and acquiring the music file from the web site, if a desired music file exists only in the music file list of the music web site.

According to another aspect of the present invention, there is provided an apparatus for performing a knowledge-based music search, including: a knowledge document acquisition unit acquiring a knowledge document from a knowledge-based search engine by using a music knowledge-based query; a header information reader reading header information of a header-based music album storage device from the knowledge document; and a music file acquisition unit acquiring a music file by searching the header-based music album storage device by using the read header information.

The knowledge document acquisition unit may acquire the knowledge document from a knowledge-based web search engine operated on the Internet by using the music knowledge-based query.

The knowledge document may be an HTML or XML type document.

The header information reader may include: a header information matching unit which searches header information of the header-based music album storage device, which exists in the knowledge document, and counts the number of matches between the header information and the knowledge document; a header information reader acquiring header information of which the number of matches between the header information and the knowledge document is greater than a predetermined number; and a query generator generating a search query for the header-based music album storage device by using the acquired header information.

The header-based music album storage device may be a local header-based music album storage device or a web-based music service storage device.

The music file acquisition unit may include: a music file list generator generating a music file list by combining music files searched for through the local header-based music album storage device and the music web site by using the generated query; and a web music file acquisition unit acquiring a music file form the music web site, if a desired music file exists only in the music file list of the music web site.

According to another aspect of the present invention, there is provided a method of performing a knowledge-based music search, including: inputting a music knowledge-based query to a knowledge-based search engine; receiving a recommendation of a music file list corresponding to the query from the knowledge-based search engine; comparing the recommended music file list with a music file list in the local music album storage device; and sorting the recommended music file list to distinguish the music file list in the local music album storage device from other music file lists, and displaying the music file list.

The method may further include acquiring a desired music file from the knowledge-based search engine, if the sorted and displayed music file list shows that the desired music file does not exist in the local music album storage device.

The method may further include: (a) reading header information of a music file from a web document; (b) reading knowledge information on a certain music relating to the read header information from the web document; and (c) generating a list by indexing the read music knowledge information and the read header information corresponding to the music knowledge information.

The method may further comprise performing the operations (a) to (c) when the web document is added or modified.

According to another aspect of the present invention, there is provided an apparatus for performing a knowledge-based music search, including: a music file list acquisition unit receiving a recommendation of a music file corresponding to a music knowledge-based query from a knowledge-based search engine; a music file list comparator comparing the recommended music file list with a music file list in the local music album storage device; and a music file list sorting/displaying unit sorting the recommended music file list to distinguish the music file list in the local music album storage device from other music file lists, and displaying the music file list.

The apparatus may further include acquiring a desired music file from the knowledge-based search engine, if the sorted and displayed music file list shows that the desired music file does not exist in the local music album storage device.

According to another aspect of the present invention, there is provided a method of managing a music file list of a knowledge-based search engine, including: managing a web document and checking for changes in the web document; reading header information of a music file from the web document, if there are any changes in the web document; reading knowledge information relating to the read header information from the web document; and generating a list by indexing the read music knowledge information and the header information corresponding to the music knowledge information.

According to another aspect of the present invention, there is provided an apparatus for managing a music file list of a knowledge-based search engine, including: a web document manager managing a web document and checking for changes in the web document; a header information reader reading header information of a music file from the web document, if there are any changes in the web document; a music knowledge information reader reading knowledge information relating to the read header information from the web document; and a list generator generating a list by indexing the read music knowledge information and the header information corresponding to the music knowledge information.

Other aspects of the present invention also provide computer-readable media having embodied thereon computer programs for executing the above-mentioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of the configuration of a music album according to an embodiment of the present invention;

FIG. 2 is a block diagram of an apparatus for performing a knowledge-based music search for a music file of a music album according to an embodiment of the present invention;

FIG. 3 is a block diagram of the detailed configuration of the header information reader 220;

FIG. 4 is a block diagram of the detailed configuration of the music file acquisition unit 240;

FIG. 5 is a flowchart of a method of performing a knowledge-based music search for a music file of a music album according to an embodiment of the present invention;

FIG. 6 is a view of an apparatus for performing a knowledge-based music search for a music file of a music album according to an embodiment of the present invention;

FIG. 7 is a block diagram of the configuration of an apparatus for performing a knowledge-based music search for a music file of a music album according to another embodiment of the present invention;

FIG. 8 is a block diagram of the configuration of a music file list manager of a knowledge-based search engine, which manages a music file list in the knowledge-based search engine;

FIG. 9 is a flowchart of a method of performing a knowledge-based music search for a music file of a music album according to another embodiment of the present invention;

FIG. 10 is a flowchart of a method of managing a music file list for a knowledge-based search engine, which manages a music file list in the knowledge-based search engine; and

FIG. 11 shows a system of the knowledge search engine, which automatically updates knowledge and music information relating to the knowledge.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

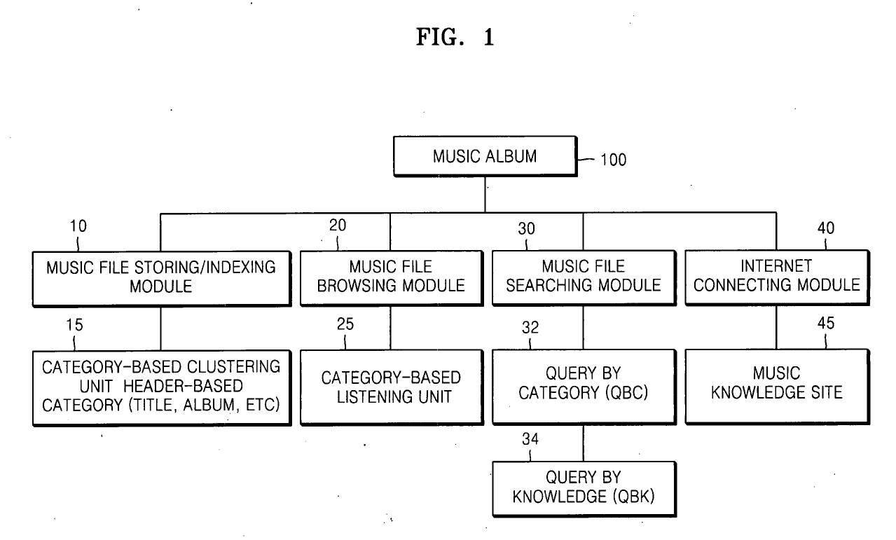

FIG. 1 is a block diagram of the configuration of a music album of an embodiment of the present invention. Referring to FIG. 1, a music album 100 of the present embodiment includes a music file storing/indexing module 10, a music file browsing module 20, a music file searching module 30, and an Internet connecting module 40. In order to store a music file, the music file is input to the music file storing/indexing module 10, and a music file catalogue is then determined based on a header of the music file to be classified according to its category (15). When searching for the music file some time later, the categorized music file is searched for using a query by category (QBC) (32) so as to listen to the music on the basis of its category (20, 25). When searching for stored music which is not in the category 10), or searching for stored music based on knowledge information relating to the music (10), the music file is searched for using a knowledge-based music search 34). The knowledge-based music search is carried out 34) by connecting to the Internet 40) and then obtaining information of a music file stored in the music album in a music site 45).

A header of the music file stored in a storage device 10) in a music album display device has information that can be represented by the following equation 1.
header={h₁,h₂, . . . ,h_{N-1},h_{N}} (1)

Here, {h₁,h₂, . . . ,h_{N-1},h_{N}} denotes information stored in the music file header, which may include the artist, genre, composer, release date, and country of origin.

The header may be directly used for a music category (module 15). The header-based category can be represented by the following equation 2.
category={h₁,h₂, . . . ,h_{N-},h_{N}} (2)

In the category-based search, a query is made by combining instances of {h₁,h₂, . . . ,h_{N-1},h_{N}}, when searching music in a music album. The query combined by the header information can be represented by the following equation 3.
query=Q(h₁,h₂, . . . ,h_{N-1},h_{N}) (3)

Here, Q denotes a combination function of {h₁,h₂, . . . ,h_{N-1},h_{N}}. The combination function may be h₁+h₂+h_{N} or h₁×h₃+h_{N}.

For example, a query of an artist “Shin Seung-hun” may be used for a category h1 area. At this time, “Shin Seung-hun” is a detailed query for a search operation in the category h1 area (i.e. artist) among category areas of header information. Normally, the search operation is performed using a query in a single category or a combination of several categories (module 32).

In this way, the music album provides a music search operation in a catalogue using the music header information in a music storage device. However, information that is not in the header (thus, not in the catalogue) cannot be searched.

In the present embodiment, the music file stored in the music album is searched based on preliminary information or general information on music (module 34).

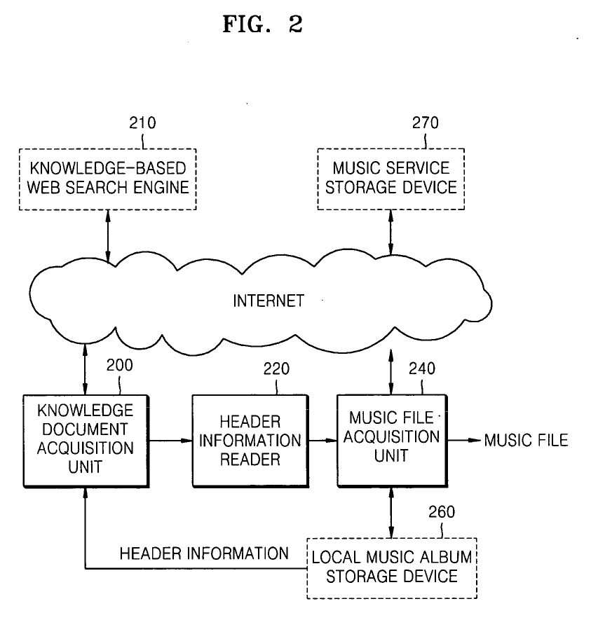

FIG. 2 is a block diagram of an apparatus for performing a knowledge-based music search for a music file of a music album according to an embodiment of the present invention, which includes a knowledge document acquisition unit 200, a header information reader 220, and a music file acquisition unit 240.

The knowledge document acquisition unit 200 acquires a knowledge document from a knowledge-based search engine using a music knowledge-based query. The knowledge-based search engine may be a knowledge-based web search engine 210 operated on the Internet. The knowledge document may be an HTML or an XML type document.

The header information reader 220 reads header information of a local music album storage device 260 from the acquired knowledge document. The local music album storage device 260 may be a header-based music album storage device.

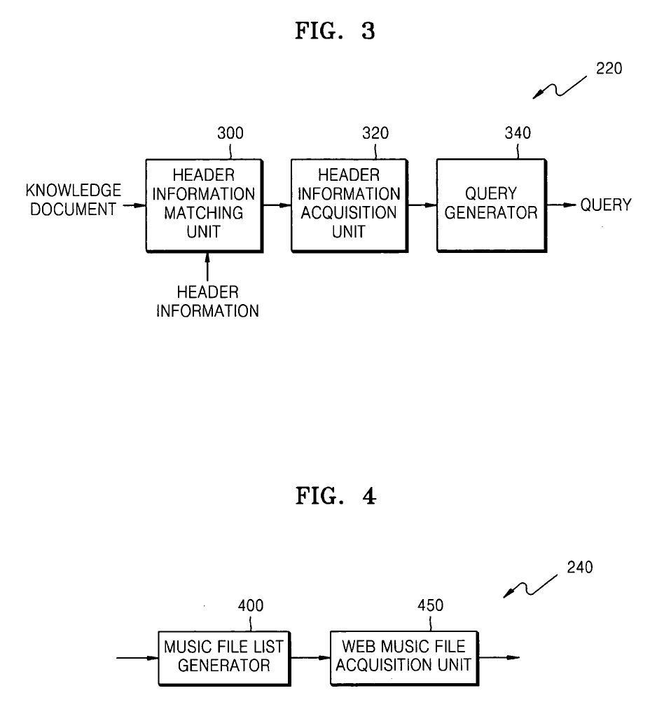

FIG. 3 is a block diagram of the detailed configuration of the header information reader 220, which includes a header information matching unit 300, a header information acquisition unit 320, and a query generator 340. The header information matching unit 300 searches the header information of the header information matching unit 300, which exists in the knowledge document, to count the number of matches between the header information and the knowledge document. The header information acquisition unit 320 acquires header information of which the number of the matching is greater than a predetermined number. The query generator 340 generates a search query for the header-based music album storage device using the acquired header information.

The music file acquisition unit 240 searches the header-based music album storage device using the read header information to acquire a music file. The header-based music album storage device may be the local music album storage device 260 or a web-based music service storage device 270.

FIG. 4 is a block diagram of the detailed configuration of the music file acquisition unit 240, which includes a music file list generator 400 and a web music file acquisition unit 450.

The music file list generator 400 searches the local music album storage device 260 and the web-based music service storage device 270 using the generated query, combines the found music files, and generates a music file list. The web music file acquisition unit 450 acquires a music file from a web site when a desired music file of the music file list only exists in the web site.

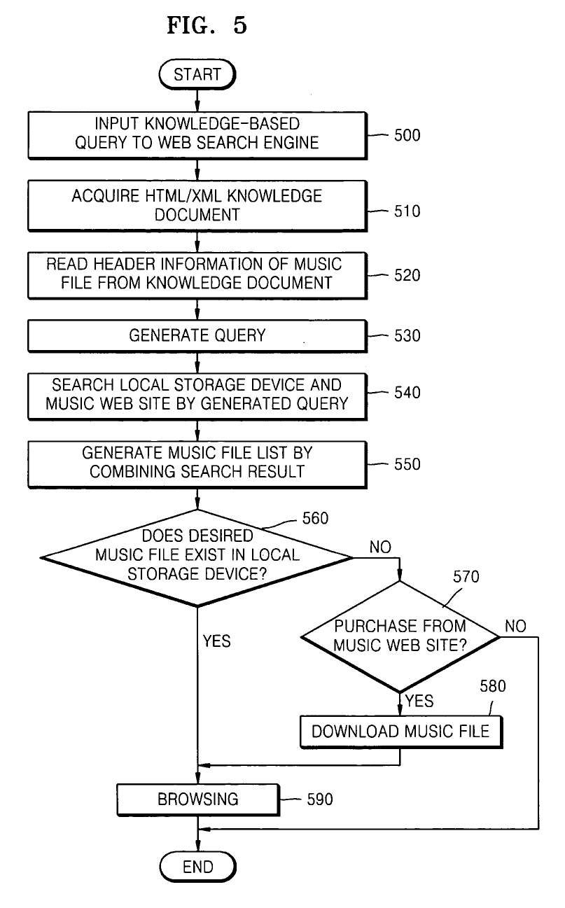

FIG. 5 is a flowchart of a method of performing a knowledge-based music search for a music file of a music album according to an embodiment of the present invention. For ease of explanation only, the method and the operation of an apparatus therefor will be described with concurrent reference to FIGS. 2 through 5.

Referring to FIGS. 2 and 5, a knowledge-based query for searching music is input. Since the current music album storage device is indexed by the header-based catalogue, a query p that does not exist in the header is difficult to search for, where the query p denotes a query for the preliminary information or general information on the music.

For the knowledge-based search, the present embodiment sends the query p to the knowledge-based web search engine 210 operated on the Internet or a general search engine (operation 500). Then, the knowledge document acquisition unit 200 acquires information of an HTML or XML type document relating to the knowledge query (operation 510). The knowledge document can be represented by the following equation 4.
extracted document={D₁,D₂, . . . ,D_{M-1},D_{M}} (4)

Here, Dm denotes a document including information relating to the query p (i.e. a key word or a key sentence). Dm can be represented by the following equation 5 relating to the knowledge-based query p.
Dₘ=T(p) (5)

Here, T(p) denotes a mapping function of the knowledge-based query p and the document Dm, and is a basic relation function used in a general search engine for searching for a document using a query.

The header information reader 220 reads the header information of the music file from the document Dm (operation 520). The header information {h₁,h₂, . . . ,h_{N-1},h_{N}} relating to the music stored in the local storage device can be acquired from the document Dm when searching the header-based music stored in the music album storage device.

A process of acquiring the header information, that is, a process of filtering information relating to the music header from the document Dm, is as follows. First, the header information matching unit 300 counts the number of matches between the header information stored in the header-based music album storage device and the knowledge document. The header information acquisition unit 320 acquires header information of which the number of matched between the header information and the knowledge document is greater than the predetermined number. The query generator 340 then converts the acquired header information into a search query for the header-based music album storage device. This will be described in detail with reference to a mathematical expression.

The following equation 6 shows whether header information hₙ, exists in the document Dm relating to the knowledge-based query p.

$$E ( {h}_{n} ) = \{ \begin{matrix}1 ( True ) & if number of occurrancefor {h}_{n} in {D}_{m} > Threshold \\ 0 ( False ) & Otherwise\end{matrix} \qquad ( 6 )$$

Here, the threshold is a critical value that determines a meaningful header by counting the number of occurrence for hₙ in Dm. While an example of a filtering method of acquiring hₙ from a document has been described, it is to be understood that other methods are possible to obtain the function E(hₙ) by natural language processing. An extraction of header information of the music file stored in the local storage device from the document Dm can be represented by the following equation 7.
{h′₁,h′₂, . . . ,h′_{N-1},h′_{N}}={h₁×E(h₁),h₂×E(h₂), . . . ,h_{N-1}×E(h_{N-1}),h_{N}×E(h_{N})} (7)

A query relating to the music header that is read from the document Dm read from an external system based on information on the knowledge-based query p can be represented by the following mathematical expression 8.
converted query=Q(h′₁,h′₂, . . . ,h′_{N-1},h′_{N}) (8)

Using the aforementioned method, a user inputs the query p relating to the preliminary information and knowledge on the music to be searched for on a local music device (operation 500), a document relating to the music is searched for on the Internet by the query p (operation 510), information of the header for the local music device is filtered from the document (operation 520), and the information is converted into a query for the header-based catalogue (operation 530).

The query converted by the music file acquisition unit 240 is converted into the knowledge-based query p to search for music in the local storage device (operation 540). The converted catalog query is recommended by the web-based music service storage device 270 of a music provider's site which is referred to (operation 540).

Next, the music file list generator 400 compares a search result from the local music album storage device 260 with a recommendation list from the web-based music service storage device 270 so as to create a music file list to show the user (operation 550). The user can listen to the music by selecting a desired music file while browsing the music file list. At this time, the user checks whether the desired music file exists in the local music album storage device 260 (operation 560), and if it exists, the user directly listens to the music file through browsing (operation 590). If the desired music file does not exist in the local music album storage device 260 and only exists in the web-based music service storage device 270 (operation 570), and if the user desires to purchase the music file through the web-based music service storage device 270 (operation 570), the user purchases and downloads the music file through the web music file acquisition unit 450 (operation 580).

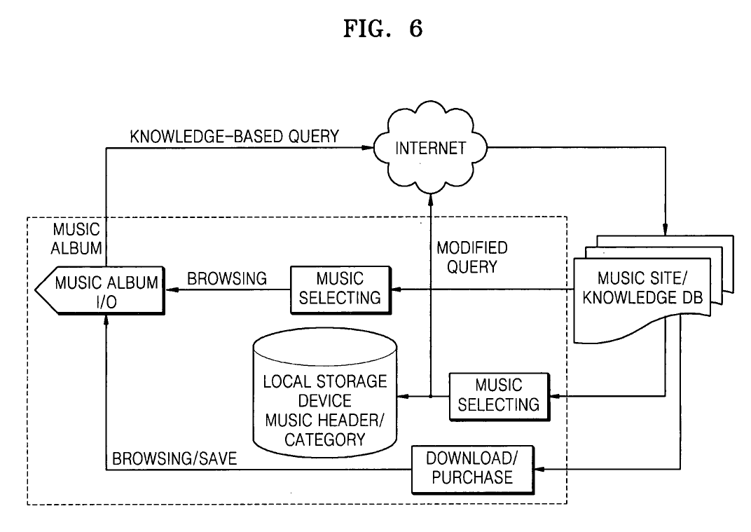

FIG. 6 is a view of an apparatus for performing a knowledge-based music search for a music file of a music album according to an embodiment of the present invention.

In another embodiment of the present invention, the apparatus for searching for a music file may directly provide the music file list when a knowledge-based query is input to the apparatus. In this case, the music list relating to the knowledge-based query p that the user desires to use to search through the knowledge-based search engine can be directly recommended.

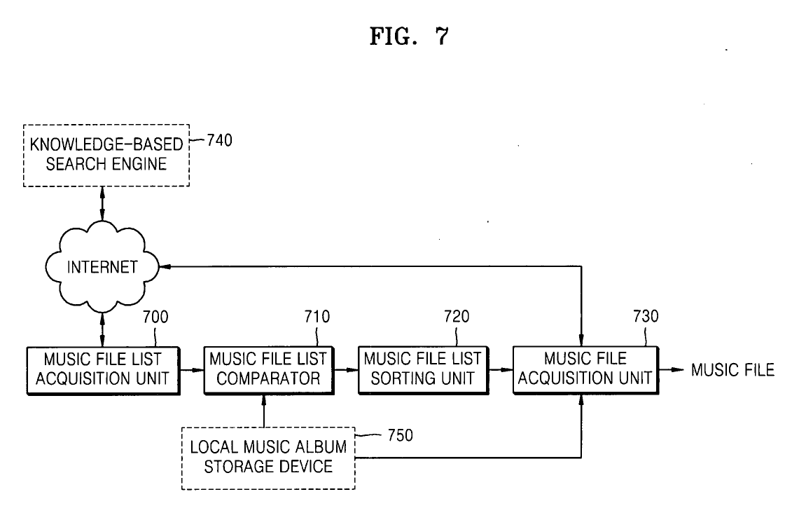

FIG. 7 is a block diagram of the configuration of an apparatus for performing a knowledge-based music search for a music file of a music album according to another embodiment of the present invention. The apparatus for searching for a music file includes a music file list acquisition unit 700, a music file list comparator 710, and a music file list sorting unit 720. An optional a music file acquisition unit 730 is also included.

The music file list acquisition unit 700 acquires a music file list that is searched by a knowledge-based query from a knowledge-based search engine 740. The music file list comparator 710 compares the music file list with a music file list in a local music album storage device 750. The music file list sorting unit 720 sorts the recommended music file list so as to distinguish the music file list in the local music album storage device 750 from other music file lists, and displays the music file list. The music file acquisition unit 730 acquires a desired music file from the knowledge-based search engine 740 when the sorted and displayed music file list shows that the desired music file does not exist in the local music album storage device 750.

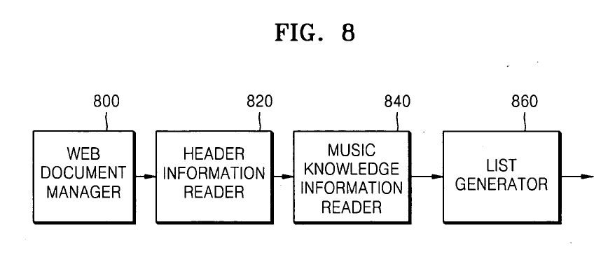

FIG. 8 is a block diagram of the configuration of a music file list manager of a knowledge-based search engine, which manages a music file list in the knowledge-based search engine. The music file list manager includes a web document manager 800, a header information reader 820, a music knowledge information reader 840, and a list generator 860.

The web document manager 800 manages a web document and checks for any changes in the web document. The header information reader 820 reads header information of a music file from the web document when the web document manager 800 recognizes any changes in the web document. The header information may include a music title and composer. The music knowledge information reader 840 reads knowledge information relating to the read header information from the web document. The list generator 860 generates a list by indexing the music knowledge information that is read from the music knowledge information reader 840 and the header information corresponding to the music knowledge information.

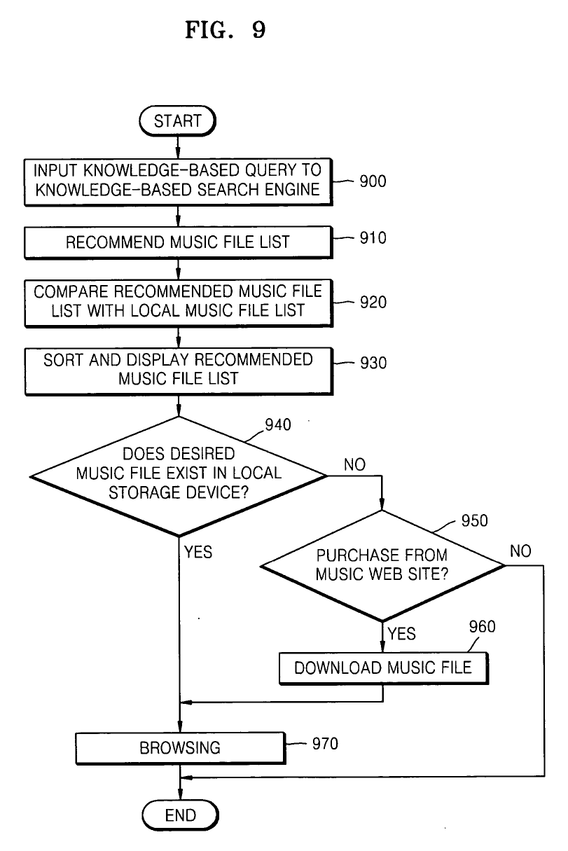

FIG. 9 is a flowchart of a method of performing a knowledge-based music search for a music file of a music album according to another embodiment of the present invention. For ease of explanation only, the method is described in conjunction with the apparatus of FIG. 7. Referring to FIGS. 7 and 9, first, a user inputs a music knowledge-based query to a knowledge-based search engine, advantageously the web-based knowledge-based search engine 740 (operation 900), and then a music file list corresponding to the query is recommended from the knowledge-based search engine 740 through the music file list acquisition unit 700 (operation 910).

Next, the music file list comparator 710 compares the recommended music file list with a music file list in the local music album storage device 750 (operation 920). Then, the music file list sorting unit 720 sorts the recommended music file list so as to distinguish the music file list in the local music album storage device 750 from other music file lists, and displays the music file list (operation 930).

The user can listen to music by selecting a desired music file while browsing the music file list. At this time, the user checks whether the desired music file exists in the local music album storage device 750 (operation 940), and if it exists, the user directly listens to the music file through browsing (operation 970). If the desired music file does not exist in the local music album storage device 750 and only exists in the web-based music service storage device 740, and if the user desires to purchase the music file through the web-based music service storage device 740 (operation 950), the user purchases and downloads the music file through the web music file acquisition unit 730 (operation 960), thereby obtaining the music file (operation 970).

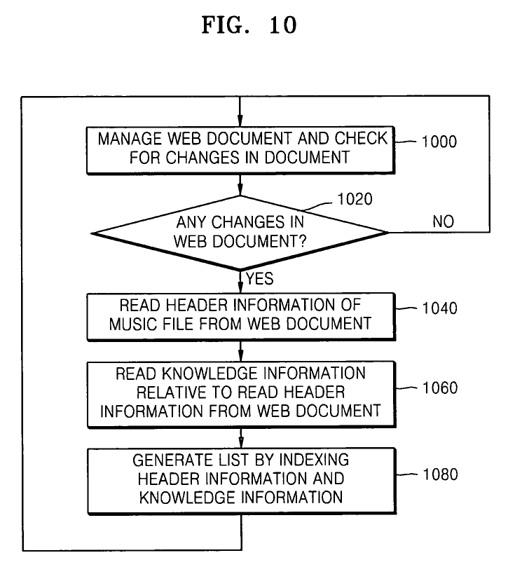

A music file list managing operation performed by the knowledge-based search engine 740 will be now described. For ease of explanation only, the method is described in conjunction with the apparatus of FIG. 8. FIG. 10 is a flowchart of a method of managing a music file list for a knowledge-based search engine, which manages a music file list in the knowledge-based search engine. Referring to FIGS. 8 and 10, first, the web document manager 800 manages a web document and checks for any changes in the web document (operation 1000). If no changed have been made, the process returns to operation 1000. (operation 1020). Conversely, if changes have been made, the process continues to a next operation. The header information reader 820 reads header information of a music file from the web document if there are any changes in the web document (operation 1040). The music knowledge information reader 840 reads knowledge information relating to the read header information from the web document (operation 1060). The list generator 860 generates a list by indexing the read music knowledge information and the header information corresponding to the music knowledge information (operation 1080).

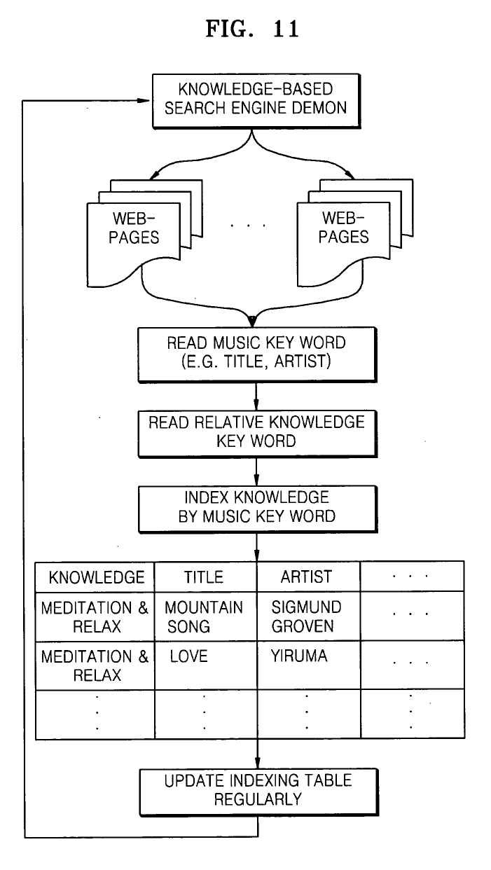

FIG. 11 shows a system of the knowledge search engine, which automatically updates knowledge-based query p and music information relating to the knowledge-based query p.

In a method and apparatus for performing a knowledge-based music search for a music file of a music album, a knowledge-based music search for a music file of a music album can be performed in a music album of a home server or a music player of a mobile phone connected to the Internet.

A knowledge-based search is carried out by converting a knowledge-based search query into a query for header information of a music file, when a user searches for the music file in a music album of the home server or the music player of the mobile phone.

In addition, a search system of an embodiment of the present invention, in which a header is indexed according to its catalog in the music album of the home server or the music player of the mobile phone, provides a knowledge-based search operation through filtering and query conversion and a search operation satisfying a user's demand, which leads to a simple and useful search operation.

Embodiments of the present invention include computer readable code on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of performing a knowledge-based music search, comprising:
(a) inputting a knowledge-based query to a knowledge-based search engine;
(b) acquiring a knowledge document relating to the music searched for by the query;
(c) reading a query for searching for a desired music file from the knowledge document; and
(d) performing a knowledge-based music search using the read query.

2. The method of claim 1, wherein the knowledge-based search engine is a knowledge-based web search engine operated on an Internet.

3. The method of claim 2, wherein the knowledge document is an HTML document or an XML type document.

4. The method of claim 1, wherein, in operation (c), header information of a header-based music album storage device is read from the knowledge document.

5. The method of claim 4, wherein operation (c) comprises:
counting a number of matches between the header information stored in the header-based music album storage device and the knowledge document;
acquiring header information of which the number of matches between the header information and the knowledge document is greater than a predetermined number; and
converting the acquired header information into a search query for the header-based music album storage device,
wherein, in operation (d), a knowledge-based music search in the header-based music album storage device is performed using the converted query.

6. The method of claim 5, wherein the header-based music album storage device is a local header-based music album storage device or a web-based music service storage device.

7. The method of claim 5, wherein operation (d) comprises:
searching for a music file using the converted search query in a local header-based music album storage device and a music web site;
generating a music file list by combining a search result from the local storage device and a search result from the music web site; and
acquiring the music file from the web site, when the music file exists only in a music file list of the music web site.

8. An apparatus for performing a knowledge-based music search, comprising:
a knowledge document acquisition unit acquiring a knowledge document from a knowledge-based search engine using a music knowledge-based query;
a header information reader reading header information of a header-based music album storage device from the knowledge document; and
a music file acquisition unit acquiring a music file by searching the header-based music album storage device using the read header information.

9. The apparatus of claim 8, wherein the knowledge document acquisition unit acquires the knowledge document from a knowledge-based web search engine operated on an Internet using the music knowledge-based query.

10. The apparatus of claim 9, wherein the knowledge document is an HTML or XML type document.

11. The apparatus of claim 8, wherein the header information reader comprises:
a header information matching unit which searches header information of the header-based music album storage device, which exists in the knowledge document, and counts the number of matches between the header information and the knowledge document;
a header information reader acquiring header information of which the number of matches between the header information and the knowledge document is greater than a predetermined number; and
a query generator generating a search query for the header-based music album storage device using the acquired header information.

12. The apparatus of claim 11, wherein the header-based music album storage device is a local header-based music album storage device or a web-based music service storage device.

13. The apparatus of claim 11, wherein the music file acquisition unit comprises:
a music file list generator generating a music file list by combining music files searched for through a local header-based music album storage device and the music web site using the generated query; and
a web music file acquisition unit acquiring a music file form the music web site, when the music file exists only in the music file list of the music web site.

14. A method of performing a knowledge-based music search, comprising:
inputting a music knowledge-based query to a knowledge-based search engine;
receiving a recommendation of a music file list corresponding to the query from the knowledge-based search engine;
comparing the recommended music file list with a music file list in a local music album storage device; and
sorting the recommended music file list to distinguish the music file list in the local music album storage device from other music file lists, and displaying the music file list.

15. The method of claim 14, further comprising acquiring a music file from the knowledge-based search engine, when the sorted and displayed music file list shows that the desired music file does not exist in the local music album storage device.

16. The method of claim 14, further comprising:
(a) reading header information of a music file from a web document;
(b) reading knowledge information on a certain music relating to the read header information from the web document; and
(c) generating a list by indexing the read music knowledge information and the read header information corresponding to the music knowledge information.

17. The method of claim 16, further comprising performing the operations (a) through (c) when the web document is added or modified.

18. An apparatus for performing a knowledge-based music search, comprising:
a music file list acquisition unit receiving a recommendation of a music file corresponding to a music knowledge-based query from a knowledge-based search engine;
a music file list comparator comparing the recommended music file list with a music file list in a local music album storage device; and
a music file list sorting/displaying unit sorting the recommended music file list to distinguish the music file list in the local music album storage device from other music file lists, and displaying the music file list.

19. The apparatus of claim 18, further comprising acquiring a music file from the knowledge-based search engine, when the sorted and displayed music file list shows that the desired music file does not exist in the local music album storage device.

20. A method of managing a music file list of a knowledge-based search engine, comprising:
managing a web document and checking for changes in the web document;
reading header information of a music file from the web document, when there are changes in the web document;
reading knowledge information relating to the read header information from the web document; and
generating a list by indexing the read music knowledge information and the header information corresponding to the music knowledge information.

21. An apparatus for managing a music file list of a knowledge-based search engine, comprising:
a web document manager managing a web document and checking for changes in the web document;
a header information reader reading header information of a music file from the web document, when there are changes in the web document;
a music knowledge information reader reading knowledge information relating to the read header information from the web document; and
a list generator generating a list by indexing the read music knowledge information and the header information corresponding to the music knowledge information.

22. A computer-readable medium having embodied thereon a computer program for executing the method of claim 1.

23. A computer-readable medium having embodied thereon a computer program for executing the method of claim 14.

24. A computer-readable medium having embodied thereon a computer program for executing the method of claim 20.
